(19) United States
(12) Patent Application Publication
(10) Pub. No.: US 2026/0231151 A1
(43) Pub. Date: Aug. 6, 2026

(54) ENHANCED MULTIPLEXING OF UPLINK CONTROL INFORMATION WITH DIFFERENT PHYSICAL LAYER PRIORITIES

(71) Applicant: Intel Corporation, Santa Clara, CA (US)

(72) Inventors: Toufiqul ISLAM, Milpitas, CA (US); Debdeep CHATTERJEE, San Jose, CA (US); Sergey PANTELEEV, Leixlip (IE); Salvatore TALARICO, Sunnyvale, CA (US)

(73) Assignee: Intel Corporation, Santa Clara, CA (US)

(21) Appl. No.: 19/634,038

(22) Filed: Mar. 30, 2026

Related U.S. Application Data
(63) Continuation of application No. 18/571,718, filed on Aug. 3, 2022.
(60) Provisional application No. 63/230,661, filed on Aug. 6, 2021.

(51) Int. Cl. H04W 72/20; H04W 72/563

(52) U.S. Cl. CPC H04W 72/20; H04W 72/563

(57) ABSTRACT

This disclosure describes systems, methods, and devices related to multiplexing uplink transmissions. A user equipment (UE) device may detect a first set of beta offset indices associated with multiplexing high priority uplink control information (UCI) into a physical uplink shared control channel (PUSCH); detect a second set of beta offset indices associated multiplexing low priority UCI into the PUSCH; detect downlink control information (DCI) using a physical downlink control channel (PDCCH) which schedules the PUSCH; determine, based on the first set of beta offset indices and the second set of beta offset indices, that UE device is to multiplex the high priority UCI with the low priority UCI into the PUSCH; and encode, based on the second set of beta offset indices, a multiplexed uplink transmission for transmission to the 5G network device using the PUSCH, the multiplexed uplink transmission comprising the high priority UCI and the low priority UCI.

### CROSS-REFERENCE TO RELATED PATENT APPLICATION(S)

This application is a continuation application of U.S. application Ser. No. 18/571,718, filed Dec. 18, 2023, which is a U.S. National Stage Application under 35 U.S.C. 371 and claims the priority benefit of International Application No. PCT/US2022/039316, filed Aug. 3, 2022, which claims the benefit of U.S. Provisional Application No. 63/230,661, filed Aug. 6, 2021, the disclosures of which are incorporated by reference as set forth in full.

### TECHNICAL FIELD

This disclosure generally relates to systems and methods for wireless communications and, more particularly, to multiplexing of uplink control information having different physical layer priorities.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating example processes for sending multiplexed low priority and high priority uplink transmissions, according to some example embodiments of the present disclosure.

FIG. 2 is a network diagram illustrating an example process for sending multiplexed low priority and high priority uplink transmissions, according to some example embodiments of the present disclosure.

FIG. 3 is a network diagram illustrating an example process for sending multiplexed low priority and uplink transmissions, according to some example embodiments of the present disclosure.

FIG. 4 is a network diagram illustrating an example process for sending multiplexed high priority and uplink transmissions, according to some example embodiments of the present disclosure.

FIG. 5 illustrates a flow diagram of illustrative process for sending multiplexed low priority and high priority uplink transmissions, in accordance with one or more example embodiments of the present disclosure.

FIG. 6 illustrates a network, in accordance with one or more example embodiments of the present disclosure.

FIG. 7 schematically illustrates a wireless network, in accordance with one or more example embodiments of the present disclosure.

FIG. 8 is a block diagram illustrating components, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3rd Generation Partnership Program (3GPP) define communication techniques, including for the transmission of uplink control information (UCI). In particular, PUCCH is an uplink physical control channel that carries UCI. UCI also may be carried by a PUSCH (physical uplink shared control channel). UCI may include scheduling requests, channel state information (CSI), acknowledgements, and other information. Currently, there is no mechanism with which to multiplex UCI, particularly to allow a combination of lower and higher priority UCI transmissions to be multiplexed with one another, to multiplex high priority UCI on a low priority control channel, or to multiplex low priority UCI on a high priority control channel. In particular, 3GPP allows for dropping a low priority UCI transmission to allow for a higher priority UCI transmission.

Alpha parameters may be used to signal to a user equipment (UE) device the maximum number of frequency resources that can be used for a UCI transmission, and beta parameters may be used to signal to the UE the actual number of frequency resources to use for a UCI transmission. The alpha and beta parameters may be signaled using downlink control information (DCI) sent by the network. For example, beta values may be represented by codepoints: 00, 01, 10, 11-corresponding to a table index of beta values. There is currently no technique for using separate beta values for high priority and low priority UCI transmissions multiplexed into a single transmission.

Different services may be supported in a carrier or serving cell. A 3GPP new release (NR) UE may support one or more service types. If communication of more than one service type with varying reliability and latency requirements can be made in a carrier/serving cell, it is possible that scheduled/configured resource for transmission of a first service type may overlap with resource for transmission of a second service type for a given UE. In order to handle collision and prioritize more urgent transmission, the Release 16 3GPP specification allows for scheduling or configuring resource for a transmission of either high or low priority where the priority level is indicated to the UE. A configured UE may transmit a high priority transmission and drop the low priority transmission in uplink (UL) in case of an overlap. However, always dropping the lower priority transmission can be detrimental for spectral efficiency and for the UE-perceived throughput for the low priority transmission, which may potentially carry high payload control information of one or multiple carriers.

Therefore, a solution is necessary for efficient multiplexing of UL transmissions of ‘high’ and ‘low’ priority for a given UE which may provide better flexibility in resource management without sacrificing quality of service (QoS) requirements for either service types much.

Various embodiments herein provide mechanisms for multiplexing low and high priority UCI bits in a PUCCH. Embodiments may enhance system spectral efficiency and scheduling flexibility.

In the following embodiments/examples, multiplexing of Physical UL Shared channel (PUSCH) and UL control information (UCI) transmissions are discussed for a given UE where PUSCH and UCI can be of different priority, or the channel may be a different priority than the information being transmitted. PUSCH can be dynamic grant-based or configured-grant based (type 1 or type 2), unless otherwise mentioned. Types of UCI that can be multiplexed onto PUSCH include HARQ-ACK, CSI etc. Examples below mainly consider HARQ-ACK as the type of UCI which may be associated with high priority (HP) or low priority (LP). HARQ-ACK information may correspond to dynamic grant-based PDSCH or semi-persistently scheduled (SPS-) PDSCH. The priority of PUSCH (and HARQ-ACK) can be obtained from the UL grant scheduling the PUSCH or higher layer configuration if PUSCH is based on configured-grant (and the DL grant scheduling the corresponding PDSCH or higher layer configuration of the corresponding SPS-PDSCH, respectively). In the examples below, it is assumed that for multiplexing HARQ-ACK onto PUSCH, timeline requirements as defined in Section 9.2.5 in TS38.213 of 3GPP are satisfied. In the examples below, if a value is configured, it is implied that it is signaled to UE via higher layer signaling such as UE specific RRC signaling. UL and DL grant also imply UL scheduling DCI and DL scheduling DCI respectively.

The amount of resources of PUSCH that is allocated to the multiplexed UCI is determined based on beta offset values, which can be dynamically indicated in the UL grant scheduling the PUSCH or obtained from higher layer configuration. In particular, for HARQ-ACK and CSI (e.g., CSI part 1, part 2, cf. TS 38.213), separate beta offset values are configured/indicated as {β^{HARQ-ACK}, β^{CSI-1}, β^{CSI-2}}. Depending on UCI payload, further categorization of beta offset values are identified. For example, per Rel-15 specifications, β^{HARQ-ACK} is classified into betaOffsetACKIndex1, betaOffsetACK-Index2, and betaOffsetACK-Index3 which are used for HARQ-ACK bits up to 2, 2 to 11, and larger than 11 bits, respectively. Similarly, betaOffsetCSI-Part1-Index1 and betaOffsetCSI-Part2-Index1 is for up to 11 bits and betaOffsetCSI-Part1-Index2 and betaOffsetCSI-Part2-Index2 is for payload more than 11 bits. Lowest (highest) beta offset value in Rel-15 design is 1.0 (126). The higher the value, the more resources are allocated to UCI from PUSCH. For HARQ-ACK transmission on PUSCH with UL-SCH, the number of coded modulation symbols per layer for HARQ-ACK transmission can be obtained based on beta offsets, such as following Section 6.3.2.4.1.1 of TS 38.212 of 3GPP.

A common beta offset β^{HARQ-ACK} for HARQ-ACKs of different priorities may not result in appropriate resource allocation for protecting the reliability of the high priority (HP) HARQ-ACK, or of priority index 1. Hence, HARQ-ACKs of different priorities can be separately encoded with different β^{HARQ-ACK} values for multiplexing onto PUSCH. Depending on the priority of the HARQ-ACKs and PUSCH, the following Scenarios 1-6 could occur:
1. Multiplexing LP HARQ-ACK/UCI on LP PUSCH
2. Multiplexing LP HARQ-ACK/UCI on HP PUSCH
3. Multiplexing HP HARQ-ACK/UCI on LP PUSCH
4. Multiplexing HP HARQ-ACK/UCI on HP PUSCH
5. Multiplexing LP HARQ-ACK/UCI, HP HARQ-ACK/UCI on LP PUSCH
6. Multiplexing HP HARQ-ACK/UCI, LP HARQ-ACK/UCI on HP PUSCH

For scenarios 1 to 4, separate beta offset configurations can be used. Per Rel-15 (3GPP Release 15) specifications, a 2-bit beta_offset indicator field in the UL grant DCI indicates a beta offset. Hence, a set of four beta offset values, e.g., for each of betaOffsetACKIndex1, betaOffsetACK-Index2, and betaOffsetACK-Index3 as mentioned above can be configured from a corresponding table. However, if HARQ-ACKs of both priority 1 and 0 would be multiplexed onto PUSCH such as in scenario 5 and 6, several options can be considered for selection of beta offset values to be applied for each of HP HARQ-ACK and LP HARQ-ACK.

In one embodiment, for scenario 5 above, a beta offset configuration corresponding to scenario 1 and 3 may be applicable, i.e., two sets of beta offsets, if the UE would multiplex both HP and LP HARQ-ACKs onto a LP PUSCH. A beta offset indicator field in the DCI scheduling LP PUSCH may indicate an index of an appropriate beta offset value from the corresponding set. For example, β^{HARQ-ACK} for each of scenario 1 to 4 mentioned above is classified into betaOffsetACKIndex1, betaOffsetACK-Index2, and betaOffsetACK-Index3, as mentioned above, and each of them have a set of four beta offset values or indices from a table.

In one example, if codepoint 00 is indicated when UE would multiplex HARQ-ACKs according to scenario 5, the first index in the corresponding set of beta offsets from the beta offset configuration of scenario 1 and 3 would apply. The first index to which one of the three classifications for each of the set of beta offsets according to scenario 1 and 3 above would apply depends on a payload of LP and HP HARQ-ACK bits to be multiplexed, respectively. A similar example can be obtained for scenario 6, i.e., corresponding to scenario 2 and 4 would be applicable, i.e., two sets of beta offsets, if the UE would multiplex both HP and LP HARQ-ACKs onto HP PUSCH.

In a variation of the above embodiment, mapping of a codepoint in the beta offset indicator field to the entries (e.g., four indices or beta-offset values if 2 bit field is used) in the set of beta offsets can be different depending on the multiplexing scenario. For example, a set of beta offsets configured for scenario 1 can also be used when scenario 5 occurs, i.e., a set of beta offsets applicable to encode and multiplex LP HARQ-ACKs bits onto LP PUSCH resource can be common. However, mapping of DCI codepoint to entries in the set can be different depending on whether using scenario 1 or scenario 5. For example, in scenario 1, DCI codepoint 00 of beta offset indicator field in UL grant scheduling LP PUSCH could map to first index in the set of beta offsets for LP HARQ-ACK, whereas codepoint 00 could map to a different entry in the set of beta offsets for LP HARQ-ACK for multiplexing according to scenario 5. This is because amount and/or % of resource allocation, i.e., potentially selection of beta offset, for multiplexing LP HARQ-ACK onto LP PUSCH could change depending on whether there is also HP HARQ-ACK to multiplex onto the same LP PUSCH or not. A similar example can also be considered for scenario 6, and mapping of codepoint to the entries in the set of beta offsets configured for scenario 2 and/or 4 could change in scenario 6. Hence, in one example, UE may be provided by higher layer UE specific RRC signaling with a separate mapping of codepoint of the beta offset indicator field to the entries of the beta offset to apply for multiplexing LP HARQ-ACK (HP HARQ-ACK) onto a LP PUSCH depending on whether HP HARQ-ACK (LP HARQ-ACK) would also be multiplexed on the LP PUSCH. Similarly, in another example, a UE may be provided by higher layer UE specific RRC signaling with a separate mapping of codepoint of the beta offset indicator field to the entries of the beta offset to apply for multiplexing LP HARQ-ACK (HP HARQ-ACK) onto a HP PUSCH depending on whether a HP HARQ-ACK (LP HARQ-ACK) would also be multiplexed onto the HP PUSCH. In one example, separate mapping of codepoints to entries in the set of beta offsets may only be provided for LP HARQ-ACK to be multiplexed onto LP or HP PUSCH, and the mapping does not change for HP HARQ-ACK even if there is LP HARQ-ACK to be multiplexed onto the HP or LP PUSCH.

In another embodiment, a mapping of codepoint to the entries in the set of beta offsets according to scenario 1 to 4 would not change if one or more sets of beta offsets configured for scenario 1 to 4 is used for multiplexing according to scenario 5 and 6, and if needed, payload control for LP HARQ-ACK bits can be applied if there are not enough resources for multiplexing LP HARQ-ACK onto LP or HP PUSCH after HP HARQ-ACK is multiplexed onto the PUSCH. In one example, LP HARQ-ACK bits can be compressed or bundled or partially dropped to fit within the resource constraints.

In yet another embodiment, separate beta offset configurations can also be provided for scenarios 5 and 6, i.e., set of beta offsets configuration for LP and/or HP HARQ-ACK for use in scenario 5 (scenario 6) can be different from the set configured for a LP and/or HP HARQ-ACK for use in scenario 1 and 3 (scenario 2 and 4), respectively. In total, six beta offset configurations for HARQ-ACK multiplexing may be provided to the UE.

In one example of the above embodiments, beta offset configuration for scenario 1 and 4 can be the same, i.e., when HARQ-ACK and PUSCH share same priority.

In one embodiment, for multiplexing onto CG-PUSCH, the chosen beta offset to apply for a certain multiplexing scenario can be indicated by UE specific RRC signaling, and there can be four values of beta offset configured according to scenario 1 to 4, which can be reused in scenario 5 and 6, i.e., beta offset values configured for scenario 1 and 3 (e.g., 2 and 4) can be used in scenarios 5 and 6. Alternatively, separate beta offset values for use in scenario 5 and 6 can be provided to the UE. In another example, same beta offset configuration can be used in scenarios 1 and 4.

In one embodiment, rate matching for HARQ-ACK information of priority index 1 and 0, and CSI if present, can be obtained as follows for scenario 5 and 6. The total resource that can be allocated for UCI multiplexing onto PUSCH (of priority either 0 or 1) is given by

$$⌈ α {\sum }_{l = {l}_{0}}^{{N}_{symb , all}^{PUSCH} - 1} {M}_{s c}^{UCI} ( l ) ⌉$$

(e.g., refer to Section 6.3.2.4.1.1 of 3GPP TS 38.312 for definitions):
Step 1: Based on the total resource available for multiplexing UCI onto PUSCH (mentioned above), first the number of coded modulation symbols per layer of HARQ-ACK information for priority 1 (high priority) denoted as

$${Q}_{ACK , h p}^{′}$$

is obtained based on the beta offset (discussed in previous embodiments/examples) and then rate matching output sequence is obtained, as outlined in Section 6.3.2.4.1.1 of TS 38.312.
Step 2: Next, based on the remaining resource available

$$⌈ α {\sum }_{l = {l}_{0}}^{{N}_{symb , all}^{PUSCH} - 1} {M}_{s c}^{UCI} ( l ) ⌉ - {Q}_{ACK , h p}^{′} ,$$

the number of coded modulation symbols per layer of HARQ-ACK information for priority 0 (low priority) denoted as

$${Q}_{ACK , l p}^{′}$$

is obtained based on the beta offset (discussed in previous embodiments/examples) and then rate matching output sequence is obtained, emulating the calculations for CSI part 1 in Section 6.3.2.4.1.2 of TS 38.312.
Step 3: Next, based on the remaining resource available

$$⌈ α {\sum }_{l = {l}_{0}}^{{N}_{symb , all}^{PUSCH} - 1} {M}_{s c}^{UCI} ( l ) ⌉ - {Q}_{ACK , h p}^{′} - {Q}_{ACK , lp}^{′} ,$$

the number of coded modulation symbols per layer for CSI part 1 transmission on PUSCH with UL-SCH, denoted as

$${Q}_{CSI - 1}^{′}$$

is obtained based on the corresponding beta offset and then rate matching output sequence is obtained, emulating the calculations for CSI part 2 in Section 6.3.2.4.1.3 of TS 38.312.
Step 4: CSI-part 2 if present is dropped.

In one example of the above embodiments, the above steps apply when indicated priority of CSI is LP. Alternatively, CSI is dropped all together if the indicated priority of CSI is LP. If the indicated priority of CSI is HP, then CSI part 1 would be processed in Step 2 and then LP HARQ-ACK is processed in Step 3. If CSI part 2 is present, then LP HARQ-ACK can be dropped. In another example, LP HARQ-ACK is dropped all together if HP CSI would be multiplexed along with HP HARQ-ACK.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

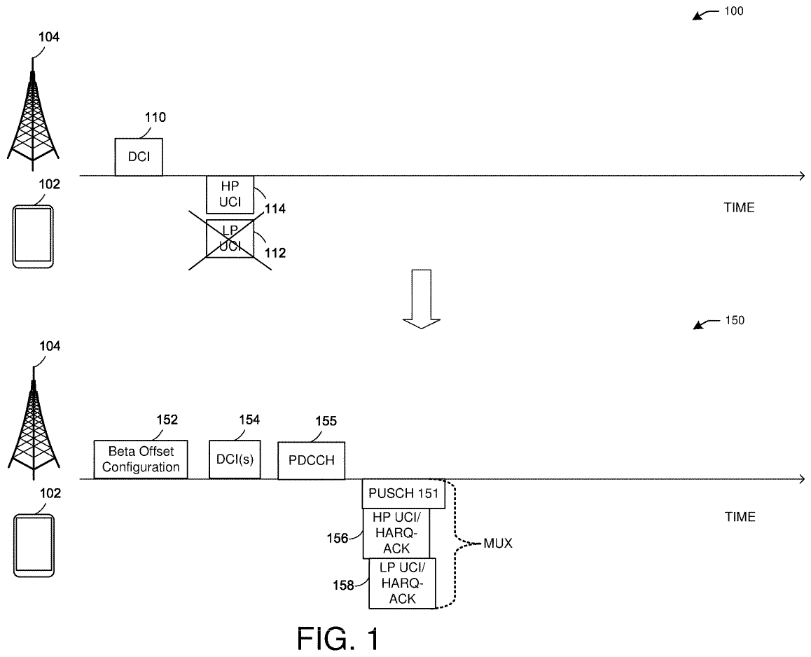

FIG. 1 is a network diagram illustrating example processes for sending multiplexed low priority and high priority uplink transmissions, according to some example embodiments of the present disclosure.

Referring to FIG. 1, a process 100 may include a UE device 102 and a 5G network device (e.g., a gNB 104). The gNB 104 may send DCI 110 in a PDCCH to indicate UL priority, such as whether the PUSCH is a high or low priority PUSCH. The UE device 102 may have a LP UCI 112 and a HP UCI 114 to transmit at an overlapping time, so the UE device 102 may drop the LP UCI 112 transmission.

Still referring to FIG. 1, a process 150 may allow for multiplexing HP and LP transmissions into a single PUSCH 151 transmission. The gNB 104 may send a beta offset configuration 152 (e.g., in higher layer RRC signaling), one or more DCIs 154, and a PDCCH 155 (e.g., including UL scheduling DCI with a beta offset indicator field including the codepoint for the beta offset indices). The beta offset configuration 152 may provide the beta offset configuration of any of the scenarios 1-6 as described above. The beta offset configuration 152 may include a codepoint that the UE device 102 may map to beta offset tables. The one or more DCIs 154 may trigger the UE device 102 to transmit HP UCI/HARQ-ACK 156 and a LP UCI/HARQ-ACK 158 (e.g., Scenario 6 described above). Upon reception of the one or more DCIs 154, the UE device 102 may determine that the HP UCI/HARQ-ACK 156 and the LP UCI/HARQ-ACK 158 may be overlapping UCIs (e.g., at least partially overlapping) and may overlap (e.g., at least partially) with the PUSCH 151. Accordingly, the UE device 102 may transmit the HP UCI/HARQ-ACK 156 and the LP UCI/HARQ-ACK 158 as a multiplexed uplink transmission using the PUSCH 151. The beta offset configuration 152 may be included in RRC signaling sent to the UE device 102.

In one or more embodiments, the beta offset configuration 152 may include a first set of beta offset indices associated with multiplexing a HP HARQ-ACK into the PUSCH 151 transmission and second set of beta offset indices associated with multiplexing a LP HARQ-ACK into the PUSCH 151 transmission, where the PUSCH 151 can be LP (e.g., scenario 5) or HP (e.g., scenario 6). When both HP and LP HARQ-ACKs are present for multiplexing, the above two sets of beta offset indices may indicate respective beta offsets (i.e., there are not separate sets of beta offset indices considered for multiplexing when both HP and LP HARQ-ACKs are present).

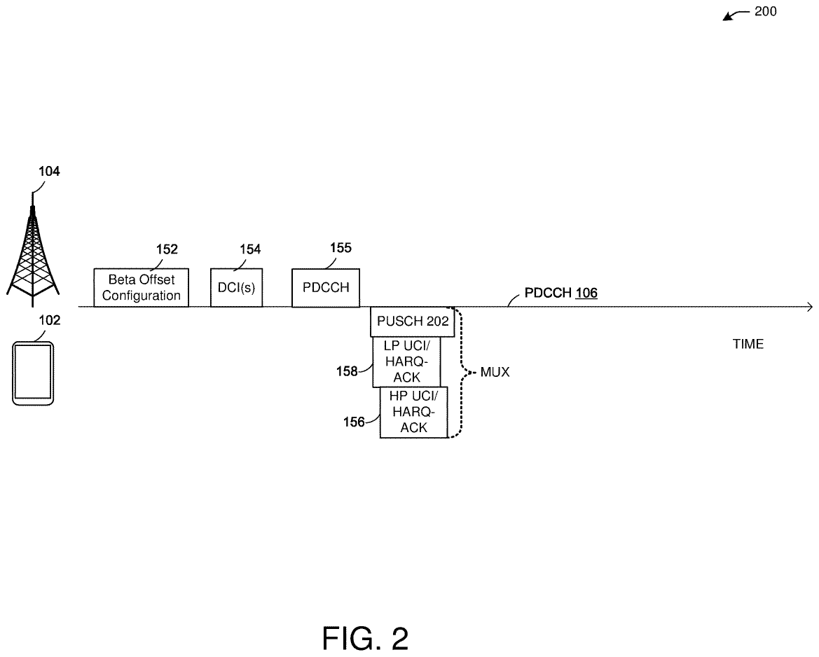

FIG. 2 is a network diagram illustrating an example process 200 for sending multiplexed low priority and high priority uplink transmissions, according to some example embodiments of the present disclosure.

Referring to FIG. 2, the process 200 may allow for multiplexing HP and LP transmissions into a single PUSCH 202 transmission. The gNB 104 may send the beta offset configuration 152, the one or more DCIs 154, and the PDCCH 155 of FIG. 1. The beta offset configuration 152 may provide the beta offset configuration of any of the scenarios 1-6 as described above. The one or more DCIs 154 may trigger the UE device 102 to transmit the LP UCI/HARQ-ACK 158 and the HP UCI/HARQ-ACK 156 (e.g., Scenario 5 described above). Because the LP UCI/HARQ-ACK 158 and the HP UCI/HARQ-ACK 156 may at least partially overlap with one another and with the PUSCH 202, the UE device 102 may transmit the LP UCI/HARQ-ACK 158 and the HP UCI/HARQ-ACK 156 as a multiplexed uplink transmission using the PUSCH 202. The beta offset configuration 152 may be included in RRC signaling sent to the UE device 102.

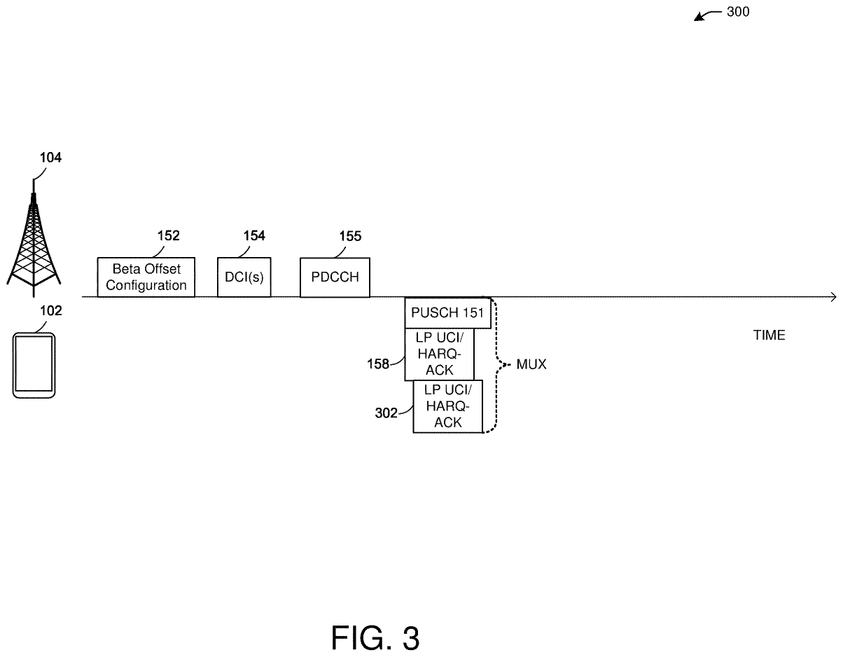

FIG. 3 is a network diagram illustrating an example process 300 for sending multiplexed low priority and uplink transmissions, according to some example embodiments of the present disclosure.

Referring to FIG. 3, the process 300 may allow for multiplexing LP transmissions into the PUSCH 151 transmission of FIG. 1. The gNB 104 may send the beta offset configuration 152, the one or more DCIs 154, and the PDCCH 155 of FIG. 1. The beta offset configuration 152 may provide the beta offset configuration of any of the scenarios 1-6 as described above. The one or more DCIs 154 may trigger the UE device 102 to transmit the LP UCI/HARQ-ACK 158 and a LP UCI/HARQ-ACK 302 (e.g., Scenario 2 described above). Because the LP UCI/HARQ-ACK 158 and the LP UCI/HARQ-ACK 302 may at least partially overlap with each other and with the PUSCH 151, the UE device 102 may transmit the LP UCI/HARQ-ACK 158 and the LP UCI/HARQ-ACK 302 as a multiplexed uplink transmission using the PUSCH 151. The beta offset configuration 152 may be included in RRC signaling sent to the UE device 102.

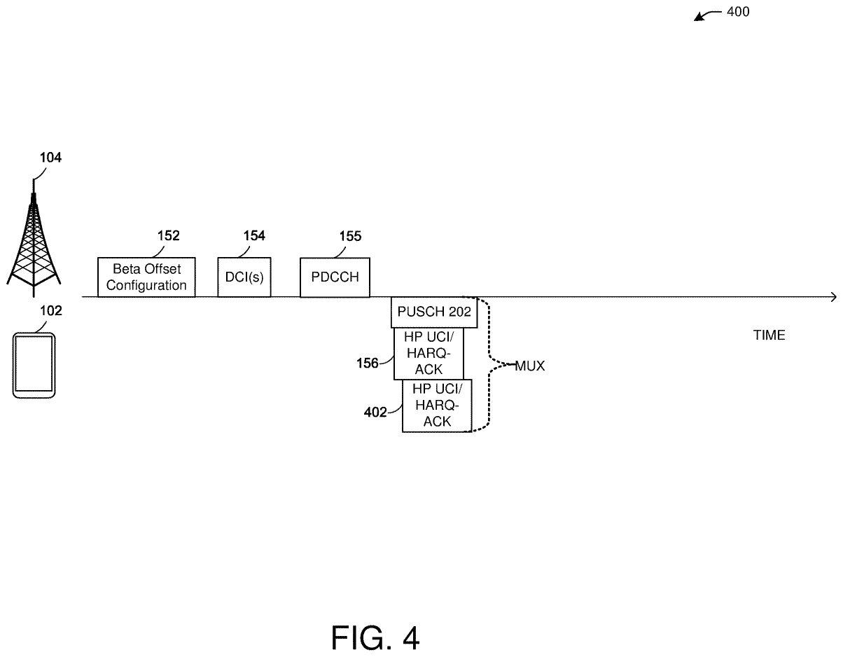

FIG. 4 is a network diagram illustrating an example process 400 for sending multiplexed high priority and uplink transmissions, according to some example embodiments of the present disclosure.

Referring to FIG. 4, the process 400 may allow for multiplexing HP transmissions into the PUSCH 202 transmission of FIG. 2. The gNB 104 may send the beta offset configuration 152, the one or more DCIs 154, and the PDCCH 155 of FIG. 1. The beta offset configuration 152 may provide the beta offset configuration of any of the scenarios 1-6 as described above. The one or more DCIs 154 may trigger the UE device 102 to transmit the HP UCI/HARQ-ACK 156 and a HP UCI/HARQ-ACK 402 (e.g., Scenario 3 described above). Because the HP UCI/HARQ-ACK 156 and the HP UCI/HARQ-ACK 402 at least partial overlap with each other and with the PUSCH 202, the UE device 102 may transmit the HP UCI/HARQ-ACK 156 and the HP UCI/HARQ-ACK 402 as a multiplexed uplink transmission using the PUSCH 202. The beta offset configuration 152 may be included in RRC signaling sent to the UE device 102.

The UE 102 may include any suitable processor-driven device including, but not limited to, a mobile device or a non-mobile, e.g., a static device. For example, the UE 102 may include, a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE 102 and the gNB 104 may include one or more communications antennas. The one or more communications antennas may be any suitable type of antennas corresponding to the communications protocols used by the UE 102 and the gNB 104. Some non-limiting examples of suitable communications antennas include 3GPP antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UE 102 and the gNB 104.

It is understood that the above descriptions are for purposes of illustration and are not meant to be limiting.

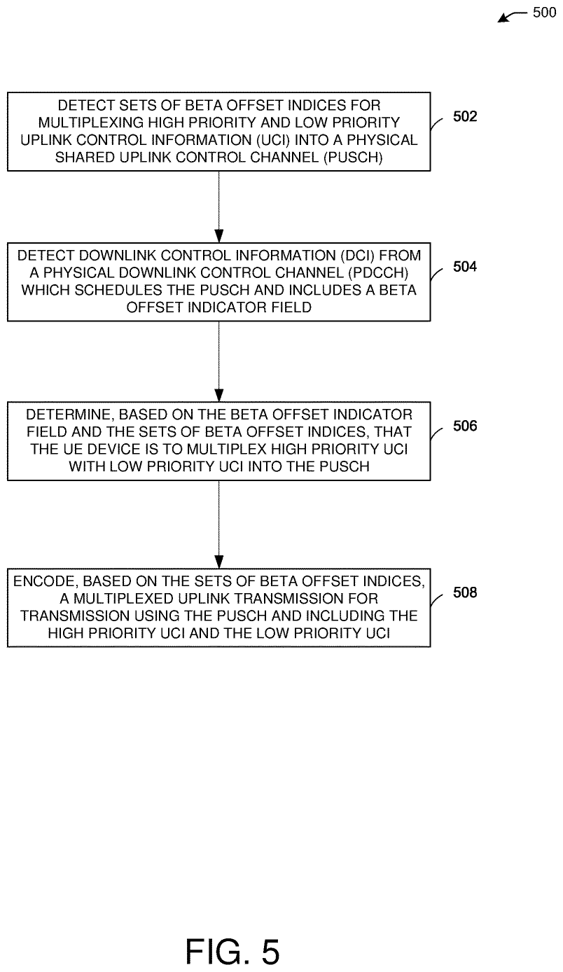

FIG. 5 illustrates a flow diagram of illustrative process for sending multiplexed low priority and high priority uplink transmissions, in accordance with one or more example embodiments of the present disclosure.

At block 502, a device (e.g., the UE device 102 of FIG. 1) may identify (e.g., detect) first and second sets of beta offset indices (e.g., from RRC signaling). A first set of beta offset indices may be used to determine PUSCH resources with which to multiplex a high priority UCI transmission. A second set of beta offset indices may be used to determine PUSCH resources with which to multiplex a low priority UCI transmission after the high priority UCI transmission has been allocated.

At block 504, the device may identify DCI (e.g., the one or more DCIs 154 of FIG. 1) received from the 5G network device. The DCI may trigger the device to transmit the high priority UCI and low priority UCI (e.g., each of which may be triggered by separate DCI). The DCI may be included in a PDCCH that schedules the PUSCH and includes a beta offset indicator field.

At block 506, the device may determine, based on the beta offset indicator field and the first and second sets of beta offset indices, that the device is to multiplex the high priority UCI and the low priority UCI into the PUSCH. In particular, the first set of beta offset indices may indicate the resources with which to multiplex the high priority UCI into the PUSCH, and the second set of beta offset indices may indicate the resources with which to multiplex the low priority UCI into the PUSCH. mapping of a codepoint in the beta offset indicator field to the entries (e.g., four indices or beta-offset values if 2 bit field is used) in the set of beta offsets can be different depending on the multiplexing scenario. For example, a set of beta offsets configured for scenario 1 can also be used when scenario 5 occurs, i.e., a set of beta offsets applicable to encode and multiplex LP HARQ-ACKs bits onto LP PUSCH resource can be common. However, mapping of DCI codepoint to entries in the set can be different depending on whether using scenario 1 or scenario 5. For example, in scenario 1, DCI codepoint 00 of beta offset indicator field in UL grant scheduling LP PUSCH could map to first index in the set of beta offsets for LP HARQ-ACK, whereas codepoint 00 could map to a different entry in the set of beta offsets for LP HARQ-ACK for multiplexing according to scenario 5. This is because amount and/or % of resource allocation, i.e., potentially selection of beta offset, for multiplexing LP HARQ-ACK onto LP PUSCH could change depending on whether there is also HP HARQ-ACK to multiplex onto the same LP PUSCH or not. A similar example can also be considered for scenario 6, and mapping of codepoint to the entries in the set of beta offsets configured for scenario 2 and/or 4 could change in scenario 6. Hence, in one example, UE may be provided by higher layer UE specific RRC signaling with a separate mapping of codepoint of the beta offset indicator field to the entries of the beta offset to apply for multiplexing LP HARQ-ACK (HP HARQ-ACK) onto a LP PUSCH depending on whether HP HARQ-ACK (LP HARQ-ACK) would also be multiplexed on the LP PUSCH. Similarly, in another example, a UE may be provided by higher layer UE specific RRC signaling with a separate mapping of codepoint of the beta offset indicator field to the entries of the beta offset to apply for multiplexing LP HARQ-ACK (HP HARQ-ACK) onto a HP PUSCH depending on whether a HP HARQ-ACK (LP HARQ-ACK) would also be multiplexed onto the HP PUSCH. In one example, separate mapping of codepoints to entries in the set of beta offsets may only be provided for LP HARQ-ACK to be multiplexed onto LP or HP PUSCH, and the mapping does not change for HP HARQ-ACK even if there is LP HARQ-ACK to be multiplexed onto the HP or LP PUSCH.

At block 508, the device may encode for transmission to the 5G network device, based on the sets of beta offset indices, a multiplexed uplink transmission including the high priority and low priority UCI multiplexed into the PUSCH (e.g., at least partially overlapping in time/frequency).

It is understood that the above descriptions are for purposes of illustration and are not meant to be limiting.

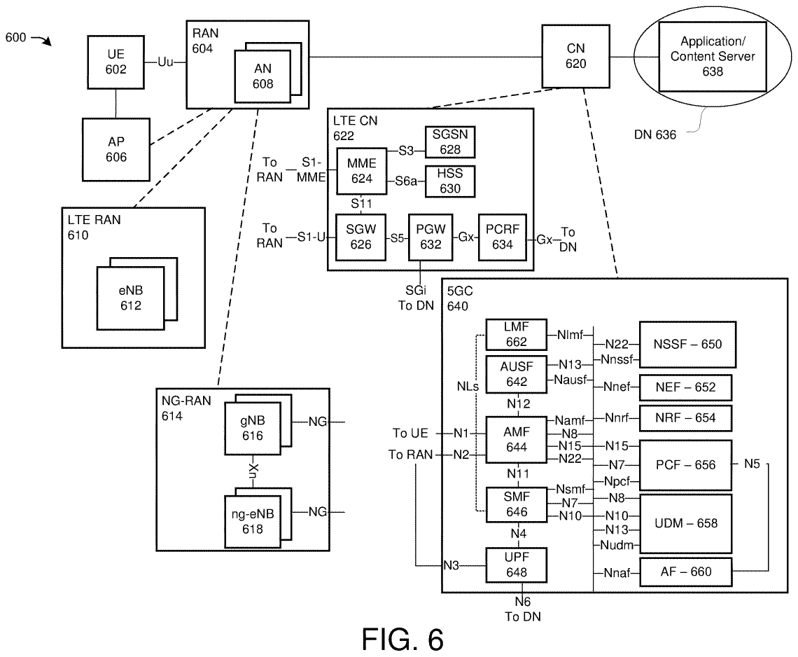

FIG. 6 illustrates a network 600, in accordance with one or more example embodiments of the present disclosure.

The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be communicatively coupled with the RAN 604 by a Uu interface. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and L1 protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN 614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various Is functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an S1 interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 636 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, AF 660, and LMF 662 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 621 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3rd party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re) selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

The LMF 662 may receive measurement information (e.g., measurement reports) from the NG-RAN 614 and/or the UE 602 via the AMF 644. The LMF 662 may use the measurement information to determine device locations for indoor and/or outdoor positioning.

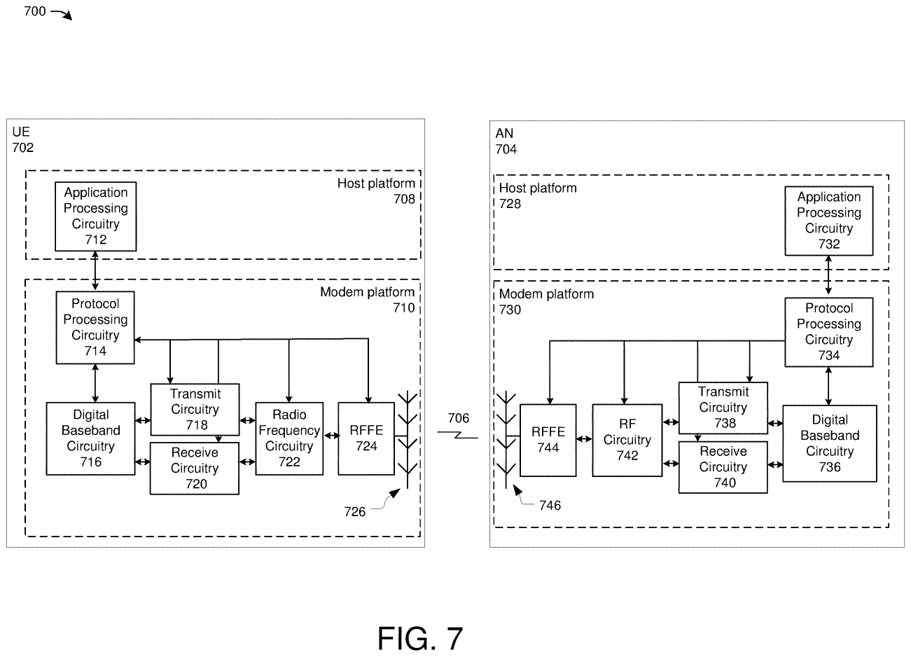

FIG. 7 schematically illustrates a wireless network 700, in accordance with one or more example embodiments of the present disclosure.

The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mm Wave or sub-6 GHz frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations.

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 712 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

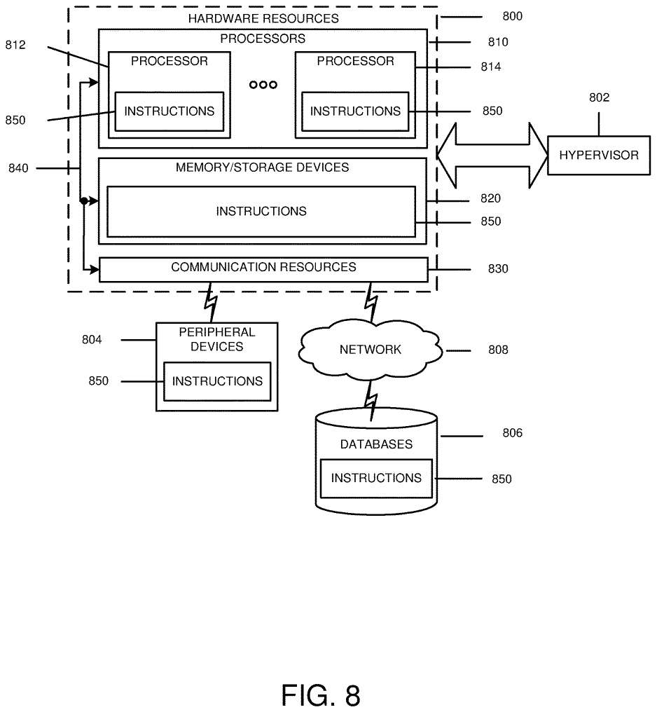

FIG. 8 is a block diagram 800 illustrating components, in accordance with one or more example embodiments of the present disclosure.

The components may be able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources from any combination of the peripheral devices 804 or the databases 806. Accordingly, the memory of processors 810, the memory/storage devices 820, the peripheral devices 804, and the databases 806 are examples of computer-readable and machine-readable media.

The following examples pertain to further embodiments.

Example 1 may be an apparatus of a user equipment device (UE) device for multiplexing uplink transmissions, the apparatus comprising processing circuitry coupled to storage, the processing circuitry configured to: detect a first set of beta offset indices, received from a fifth generation (5G) network device, the first set of beta offset indices associated with multiplexing high priority uplink control information (UCI) into a physical uplink shared control channel (PUSCH); detect a second set of beta offset indices, received from the 5G network device, the second set of beta offset indices associated multiplexing low priority UCI into the PUSCH; detect downlink control information (DCI) received from the 5G network device using a physical downlink control channel (PDCCH) which schedules the PUSCH and comprises a beta offset indicator field; determine, based on the beta offset indicator field, the first set of beta offset indices, and the second set of beta offset indices, that UE device is to multiplex the high priority UCI with the low priority UCI into the PUSCH; and encode, based on the first set of beta offset indices and the second set of beta offset indices, a multiplexed uplink transmission for transmission to the 5G network device using the PUSCH, the multiplexed uplink transmission comprising the high priority UCI and the low priority UCI.

Example 2 may include the apparatus of example 1 and/or some other example herein, wherein the PUSCH is a high priority PUSCH.

Example 3 may include the apparatus of example 1, and/or some other example herein, wherein the PUSCH is a low priority PUSCH.

Example 4 may include the apparatus of example 2 or 3 and/or some other example herein, wherein the high priority UCI comprises a high priority hybrid automatic repeat request (HARQ) acknowledgement, wherein the low priority UCI comprises a low priority HARQ acknowledgement.

Example 5 may include the apparatus of example 1 and/or some other example herein, wherein the first set of beta offset indices and the second set of beta offset indices are included in radio resource control (RRC) signaling.

Example 6 may include the apparatus of example 1 and/or some other example herein, wherein a first beta offset index of the first set of beta offset indices indicates a first amount of resources of the PUSCH with which to multiplex the high priority UCI, and wherein a second beta offset index of the second set of beta offset indices indicates a second amount of resources of the PUSCH, after the first amount of resources are allocated, with which to multiplex the low priority UCI.

Example 7 may include the apparatus of example 6 and/or some other example herein, wherein the multiplexed uplink transmission further comprises channel state information (CSI) multiplexed using a third amount of resources of the PUSCH allocated after the second amount of resources are allocated.

Example 8 may include the apparatus of example 1 and/or some other example herein, wherein the processing circuitry is further configured to: detect second DCI received from the 5G network device using the PDCCH, wherein the DCI causes the UE device to encode the high priority UCI, and wherein the second DCI causes the UE device to encode the low priority UCI.

Example 9 may include the apparatus of example 1 and/or some other example herein, wherein the processing circuitry is further configured to: encode a second multiplexed transmission for transmission to the 5G network device, the second multiplexed transmission comprising a high priority HARQ acknowledgement and high priority CSI; and refrain from multiplexing a low priority HARQ acknowledgement with the high priority HARQ acknowledgement based on the high priority CSI.

Example 10 may include the apparatus of example 1 and/or some other example herein, wherein the processing circuitry is further configured to: encode a second multiplexed transmission for transmission to the 5G network device using a low priority PUSCH, the second multiplexed transmission comprising a first high priority HARQ acknowledgement or first high priority UCI and a second high priority HARQ acknowledgement or second high priority UCI.

Example 11 may include the apparatus of example 1 and/or some other example herein, encode a second multiplexed transmission for transmission to the 5G network device using a high priority PUSCH, the second multiplexed transmission comprising a first low priority HARQ acknowledgement or low high priority UCI and a second low priority HARQ acknowledgement of second low priority UCI.

Example 12 may include a computer-readable storage medium comprising instructions to cause processing circuitry of a user equipment device (UE) device, upon execution of the instructions by the processing circuitry, to: detect a first set of beta offset indices, received from a fifth generation (5G) network device, the first set of beta offset indices associated with multiplexing high priority uplink control information (UCI) into a physical uplink shared control channel (PUSCH); detect a second set of beta offset indices, received from the 5G network device, the second set of beta offset indices associated multiplexing low priority UCI into the PUSCH; detect downlink control information (DCI) received from the 5G network device using a physical downlink control channel (PDCCH) which schedules the PUSCH and comprises a beta offset indicator field; determine, based on the beta offset indicator field, the first set of beta offset indices, and the second set of beta offset indices, that UE device is to multiplex the high priority UCI with the low priority UCI into the PUSCH; and encode, based on the first set of beta offset indices and the second set of beta offset indices, a multiplexed uplink transmission for transmission to the 5G network device using the PUSCH, the multiplexed uplink transmission comprising the high priority UCI and the low priority UCI.

Example 13 may include the computer-readable medium of example 12 and/or some other example herein, wherein the first set of beta offset indices and the second set of beta offset indices are included in radio resource control (RRC) signaling.

Example 14 may include the non-transitory computer-readable medium of example 12 and/or some other example herein, wherein a first beta offset index of the first set of beta offset indices indicates a first amount of resources of the PUSCH with which to multiplex the high priority UCI, and wherein a second beta offset index of the second set of beta offset indices indicates a second amount of frequency resources of the PUSCH, after the first amount of resources are allocated, with which to multiplex the low priority UCI.

Example 15 may include the computer-readable medium of example 14 and/or some other example herein, wherein the multiplexed uplink transmission further comprises channel state information (CSI) multiplexed using a third amount of resources of the PUSCH after the second amount of frequency resources are allocated.

Example 16 may include the computer-readable medium of example 12 and/or some other example herein, wherein execution of the instructions further causes the processing circuitry to: detect second DCI received from the 5G network device using the PDCCH, wherein the DCI causes the UE device to encode the high priority UCI, and wherein the second DCI causes the UE device to encode the low priority UCI.

Example 17 may include the computer-readable medium of example 12 and/or some other example herein, wherein the PUSCH is a high priority PUSCH.

Example 18 may include the computer-readable medium of example 12 and/or some other example herein, wherein the PUSCH is a high priority PUSCH.

Example 19 may include a method for multiplexing uplink transmissions, the method comprising: detecting, by processing circuitry of a user equipment (UE) device, a first set of beta offset indices, received from a fifth generation (5G) network device, the first set of beta offset indices associated with multiplexing high priority uplink control information (UCI) into a physical uplink shared control channel (PUSCH); detecting, by the processing circuitry, a second set of beta offset indices, received from the 5G network device, the second set of beta offset indices associated multiplexing low priority UCI into the PUSCH; detecting, by the processing circuitry, downlink control information (DCI) received from the 5G network device using a physical downlink control channel (PDCCH) which schedules the PUSCH and comprises a beta offset indicator field; determining, by the processing circuitry, based on the beta offset indicator field, the first set of beta offset indices, and the second set of beta offset indices, that UE device is to multiplex the high priority UCI with the low priority UCI into the PUSCH; and encoding, by the processing circuitry, based on the first set of beta offset indices and the second set of beta offset indices, a multiplexed uplink transmission for transmission to the 5G network device using the PUSCH, the multiplexed uplink transmission comprising the high priority UCI and the low priority UCI.

Example 20 may include the method of example 19 and/or some other example herein, wherein the PUSCH is a high priority PUSCH.

Example 21 may include the method of example 19 and/or some other example herein, wherein the PUSCH is a high priority PUSCH.

Example 22 may include the method of example 19 and/or some other example herein, wherein the first set of beta offset indices and the second set of beta offset indices are included in radio resource control (RRC) signaling.

Example 23 may include the method of example 19 and/or some other example herein, wherein a first beta offset index of the first set of beta offset indices indicates a first amount of resources of the PUSCH with which to multiplex the high priority UCI, and wherein a second beta offset index of the first set of beta offset indices indicates a second amount of resources of the PUSCH, after the first amount of resources are allocated, with which to multiplex the low priority UCI.

Example 24 may include an apparatus comprising means for: detecting, by a user equipment (UE) device, a first set of beta offset indices, received from a fifth generation (5G) network device, the first set of beta offset indices associated with multiplexing high priority uplink control information (UCI) into a physical uplink shared control channel (PUSCH); detecting a second set of beta offset indices, received from the 5G network device, the second set of beta offset indices associated multiplexing low priority UCI into the PUSCH; detecting downlink control information (DCI) received from the 5G network device using a physical downlink control channel (PDCCH) which schedules the PUSCH and comprises a beta offset indicator field; determining based on the beta offset indicator field, the first set of beta offset indices, and the second set of beta offset indices, that UE device is to multiplex the high priority UCI with the low priority UCI into the PUSCH; and encoding based on the first set of beta offset indices and the second set of beta offset indices, a multiplexed uplink transmission for transmission to the 5G network device using the PUSCH, the multiplexed uplink transmission comprising the high priority UCI and the low priority UCI.

Example 25 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 26 may include an apparatus comprising logic, modules, and/or circuitry to perform one or more elements of a method described in or related to any of examples 1-24, or any other method or process described herein.

Example 27 may include a method, technique, or process as described in or related to any of examples 1-24, or portions or parts thereof.

Example 28 may include an apparatus comprising: one or more processors and one or more computer readable media comprising instructions that, when executed by the one or more processors, cause the one or more processors to perform the method, techniques, or process as described in or related to any of examples 1-24, or portions thereof.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019 June) and/or any other 3GPP standard. For the purposes of the present document, the following abbreviations (shown in Table 1) may apply to the examples and embodiments discussed herein.

TABLE 1
Abbreviations:

| | | | | | |
|---|---|---|---|---|---|
| 3GPP | Third Generation | IBE | In-Band Emission | PUSCH | Physical Uplink Shared |
| | Partnership Project | | | | Channel |
| 4G | Fourth Generation | IEEE | Institute of Electrical | QAM | Quadrature Amplitude |
| | | | and Electronics | | Modulation |
| | | | Engineers | | |
| 5G | Fifth Generation | IEI | Information Element | QCI | QoS class of identifier |
| | | | Identifier | | |
| 5GC | 5G Core network | IEIDL | Information Element | QCL | Quasi co-location |
| | | | Identifier Data Length | | |
| AC | Application Client | IETF | Internet Engineering | QFI | QoS Flow ID, QoS |
| | | | Task Force | | Flow Identifier |
| ACK | Acknowledgement | IF | Infrastructure | QoS | Quality of Service |
| ACID | Application Client | IM | Interference | QPSK | Quadrature |
| | Identification | | Measurement, | | (Quaternary) Phase |
| | | | Intermodulation, IP | | Shift Keying |
| | | | Multimedia | | |
| AF | Application Function | IMC | IMS Credentials | QZSS | Quasi-Zenith Satellite |
| | | | | | System |
| AM | Acknowledged Mode | IMEI | International Mobile | RA-RNTI | Random Access RNTI |
| | | | Equipment Identity | | |
| AMBR | Aggregate Maximum Bit | IMGI | International mobile | RAB | Radio Access Bearer, |
| | Rate | | group identity | | Random Access Burst |
| AMF | Access and Mobility | IMPI | IP Multimedia Private | RACH | Random Access |
| | Management Function | | Identity | | Channel |
| AN | Access Network | IMPU | IP Multimedia PUblic | RADIUS | Remote Authentication |
| | | | identity | | Dial In User Service |
| ANR | Automatic Neighbour | IMS | IP Multimedia | RAN | Radio Access Network |
| | Relation | | Subsystem | | |
| AP | Application Protocol, | IMSI | International Mobile | RAND | RANDom number |
| | Antenna Port, Access | | Subscriber Identity | | (used for |
| | Point | | | | authentication) |
| API | Application Programming | IOT | Internet of Things | RAR | Random Access Response |
| | Interface | | | | |
| APN | Access Point Name | IP | Internet Protocol | RAT | Radio Access |
| | | | | | Technology |
| ARP | Allocation and Retention | Ipsec | IP Security, Internet | RAU | Routing Area Update |
| | Priority | | Protocol Security | | |
| ARQ | Automatic Repeat Request | IP-CAN | IP-Connectivity | RB | Resource block, Radio |
| | | | Access Network | | Bearer |
| AS | Access Stratum | IP-M | IP Multicast | RBG | Resource block group |
| ASP | Application Service | IPv4 | Internet Protocol | REG | Resource Element |
| | Provider | | Version 4 | | Group |
| ASN.1 | Abstract Syntax Notation | IPv6 | Internet Protocol | Rel | Release |
| | One | | Version 6 | | |
| AUSF | Authentication Server | IR | Infrared | REQ | REQuest |
| | Function | | | | |
| AWGN | Additive White Gaussian | IS | In Sync | RF | Radio Frequency |
| | Noise | | | | |
| BAP | Backhaul Adaptation | IRP | Integration Reference | RI | Rank Indicator |
| | Protocol | | Point | | |
| BCH | Broadcast Channel | ISDN | Integrated Services | RIV | Resource indicator |
| | | | Digital Network | | value |
| BER | Bit Error Ratio | ISIM | IM Services Identity | RL | Radio Link |
| | | | Module | | |
| BFD | Beam Failure Detection | ISO | International | RLC | Radio Link Control, |
| | | | Organisation for | | Radio Link Control |
| | | | Standardisation | | layer |
| BLER | Block Error Rate | ISP | Internet Service | RLC AM | RLC Acknowledged |
| | | | Provider | | Mode |
| BPSK | Binary Phase Shift Keying | IWF | Interworking-Function | RLC UM | RLC Unacknowledged |
| | | | | | Mode |
| BRAS | Broadband Remote | I-WLAN | Interworking WLAN | RLF | Radio Link Failure |
| | Access Server | | | | |
| BSS | Business Support System | | Constraint length of the | RLM | Radio Link Monitoring |
| | | | convolutional code, USIM | | |
| | | | Individual key | | |
| BS | Base Station | kB | Kilobyte (1000 bytes) | RLM-RS | Reference Signal for |
| | | | | | RLM |
| BSR | Buffer Status Report | kbps | kilo-bits per second | RM | Registration |
| | | | | | Management |
| BW | Bandwidth | Kc | Ciphering key | RMC | Reference |
| | | | | | Measurement Channel |
| BWP | Bandwidth Part | Ki | Individual subscriber | RMSI | Remaining MSI, |
| | | | authentication key | | Remaining Minimum |
| | | | | | System Information |
| C-RNTI | Cell Radio Network | KPI | Key Performance | RN | Relay Node |
| | Temporary Identity | | Indicator | | |
| CA | Carrier Aggregation, | KQI | Key Quality Indicator | RNC | Radio Network |
| | Certification Authority | | | | Controller |
| CAPEX | CAPital EXpenditure | KSI | Key Set Identifier | RNL | Radio Network Layer |
| CBRA | Contention Based Random | ksps | kilo-symbols per | RNTI | Radio Network |
| | Access | | second | | Temporary Identifier |
| CC | Component Carrier, | KVM | Kernel Virtual | ROHC | RObust Header |
| | Country Code, | | Machine | | Compression |
| | Cryptographic Checksum | | | | |
| CCA | Clear Channel Assessment | L1 | Layer 1 (physical | RRC | Radio Resource |
| | | | layer) | | Control, Radio |
| | | | | | Resource Control layer |
| CCE | Control Channel Element | L1-RSRP | Layer 1 reference | RRM | Radio Resource |
| | | | signal received power | | Management |
| CCCH | Common Control Channel | L2 | Layer 2 (data link | RS | Reference Signal |
| | | | layer) | | |
| CE | Coverage Enhancement | L3 | Layer 3 (network | RSRP | Reference Signal |
| | | | layer) | | Received Power |
| CDM | Content Delivery Network | LAA | Licensed Assisted | RSRQ | Reference Signal |
| | | | Access | | Received Quality |
| CDMA | Code-Division Multiple | LAN | Local Area Network | RSSI | Received Signal |
| | Access | | | | Strength Indicator |
| CFRA | Contention Free Random | LADN | Local Area Data | RSU | Road Side Unit |
| | Access | | Network | | |
| CG | Cell Group | LBT | Listen Before Talk | RSTD | Reference Signal Time |
| | | | | | difference |
| CGF | Charging Gateway | LCM | LifeCycle | RTP | Real Time Protocol |
| | Function | | Management | | |
| CHF | Charging Function | LCR | Low Chip Rate | RTS | Ready-To-Send |
| CI | Cell Identity | LCS | Location Services | RTT | Round Trip Time |
| CID | Cell-ID (e.g., positioning | LCID | Logical Channel ID | Rx | Reception, Receiving, |
| | method) | | | | Receiver |
| CIM | Common Information | LI | Layer Indicator | S1AP | S1 Application |
| | Model | | | | Protocol |
| CIR | Carrier to Interference | LLC | Logical Link Control, | S1-MMES1 | for the control plane |
| | Ratio | | Low Layer | | |
| | | | Compatibility | | |
| CK | Cipher Key | LPLMN | Local PLMN | S1-U | S1 for the user plane |
| CM | Connection Management, | LPP | LTE Positioning | S-GW | Serving Gateway |
| | Conditional Mandatory | | Protocol | | |
| CMAS | Commercial Mobile Alert | LSB | Least Significant Bit | S-RNTI | SRNC Radio Network |
| | Service | | | | Temporary Identity |
| CMD | Command | LTE | Long Term Evolution | S-TMSI | SAE Temporary |
| | | | | | Mobile Station |
| | | | | | Identifier |
| CMS | Cloud Management | LWA | LTE-WLAN | SA | Standalone operation |
| | System | | aggregation | | mode |
| CO | Conditional Optional | LWIP | LTE/WLAN Radio | SAE | System Architecture |
| | | | Level Integration with | | Evolution |
| | | | IPsec Tunnel | | |
| COMP | Coordinated Multi-Point | LTE | Long Term Evolution | SAP | Service Access Point |
| CORESET | Control Resource Set | M2M | Machine-to-Machine | SAPD | Service Access Point |
| | | | | | Descriptor |
| COTS | Commercial Off-The- | MAC | Medium Access | SAPI | Service Access Point |
| | Shelf | | Control (protocol | | Identifier |
| | | | layering context) | | |
| CP | Control Plane, Cyclic | MAC | Message authentication | SCC | Secondary Component |
| | Prefix, Connection Point | | code | | Carrier, Secondary CC |
| | | | (security/encryption | | |
| | | | context) | | |
| CPD | Connection Point | MAC-A | MAC used for | SCell | Secondary Cell |
| | Descriptor | | authentication and key | | |
| | | | agreement (TSG T | | |
| | | | WG3 context) | | |
| CPE | Customer Premise | MAC-I | MAC used for data | SCEF | Service Capability |
| | Equipment | | integrity of signalling | | Exposure Function |
| | | | messages (TSG T | | |
| | | | WG3 context) | | |
| CPICH | Common Pilot Channel | MANO | Management and | SC-FDMA | Single Carrier |
| | | | Orchestration | | Frequency Division |
| | | | | | Multiple Access |
| CQI | Channel Quality Indicator | MBMS | Multimedia Broadcast | SCG | Secondary Cell Group |
| | | | and Multicast Service | | |
| CPU | CSI processing unit, | MBSFN | Multimedia Broadcast | SCM | Security Context |
| | Central Processing Unit | | multicast service | | Management |
| | | | Single Frequency | | |
| | | | Network | | |
| C/R | Command/Response field | MCC | Mobile Country Code | SCS | Subcarrier Spacing |
| | bit | | | | |
| CRAN | Cloud Radio Access | MCG | Master Cell Group | SCTP | Stream Control |
| | Network, Cloud RAN | | | | Transmission Protocol |
| CRB | Common Resource Block | MCOT | Maximum Channel | SDAP | Service Data |
| | | | Occupancy Time | | Adaptation Protocol, |
| | | | | | Service Data |
| | | | | | Adaptation Protocol |
| | | | | | layer |
| CRC | Cyclic Redundancy Check | MCS | Modulation and coding | SDL | Supplementary |
| | | | scheme | | Downlink |
| CRI | Channel-State Information | MDAF | Management Data | SDNF | Structured Data |
| | Resource Indicator, CSI- | | Analytics Function | | Storage Network |
| | RS Resource Indicator | | | | Function |
| C-RNTI | Cell RNTI | MDAS | Management Data | SDP | Session Description |
| | | | Analytics Service | | Protocol |
| CS | Circuit Switched | MDT | Minimization of Drive | SDSF | Structured Data |
| | | | Tests | | Storage Function |
| CSAR | Cloud Service Archive | ME | Mobile Equipment | SDU | Service Data Unit |
| CSI | Channel-State Information | MeNB | master eNB | SEAF | Security Anchor |
| | | | | | Function |
| CSI-IM | CSI Interference | MER | Message Error Ratio | SeNB | secondary eNB |
| | Measurement | | | | |
| CSI-RS | CSI Reference Signal | MGL | Measurement Gap | SEPP | Security Edge |
| | | | Length | | Protection Proxy |
| CSI-RSRP | CSI reference signal | MGRP | Measurement Gap | SFI | Slot format indication |
| | received power | | Repetition Period | | |
| CSI-RSRQ | CSI reference signal | MIB | Master Information | SFTD | Space-Frequency Time |
| | received quality | | Block, Management | | Diversity, SFN and |
| | | | Information Base | | frame timing difference |
| CSI-SINR | CSI signal-to-noise and | MIMO | Multiple Input | SFN | System Frame Number |
| | interference ratio | | Multiple Output | | |
| CSMA | Carrier Sense Multiple | MLC | Mobile Location | SgNB | Secondary gNB |
| | Access | | Centre | | |
| CSMA/CA | CSMA with collision | MM | Mobility Management | SGSN | Serving GPRS Support |
| | avoidance | | | | Node |
| CSS | Common Search Space, | MME | Mobility Management | S-GW | Serving Gateway |
| | Cell-specific Search Space | | Entity | | |
| CTF | Charging Trigger Function | MN | Master Node | SI | System Information |
| CTS | Clear-to-Send | MNO | Mobile Network | SI-RNTI | System Information |
| | | | Operator | | RNTI |
| CW | Codeword | MO | Measurement Object, | SIB | System Information |
| | | | Mobile Originated | | Block |
| CWS | Contention Window Size | MPBCH | MTC Physical | SIM | Subscriber Identity |
| | | | Broadcast CHannel | | Module |
| D2D | Device-to-Device | MPDCCH | MTC Physical | SIP | Session Initiated |
| | | | Downlink Control | | Protocol |
| | | | CHannel | | |
| DC | Dual Connectivity, Direct | MPDSCH | MTC Physical | SiP | System in Package |
| | Current | | Downlink Shared | | |
| | | | CHannel | | |
| DCI | Downlink Control | MPRACH | MTC Physical | SL | Sidelink |
| | Information | | Random Access | | |
| | | | CHannel | | |
| DF | Deployment Flavour | MPUSCH | MTC Physical Uplink | SLA | Service Level |
| | | | Shared Channel | | Agreement |
| DL | Downlink | MPLS | MultiProtocol Label | SM | Session Management |
| | | | Switching | | |
| DMTF | Distributed Management | MS | Mobile Station | SMF | Session Management |
| | Task Force | | | | Function |
| DPDK | Data Plane Development | MSB | Most Significant Bit | SMS | Short Message Service |
| | Kit | | | | |
| DM-RS, | Demodulation | MSC | Mobile Switching | SMSF | SMS Function |
| DMRS | Reference Signal | | Centre | | |
| DN | Data network | MSI | Minimum System | SMTC | SSB-based |
| | | | Information, MCH | | Measurement Timing |
| | | | Scheduling | | Configuration |
| | | | Information | | |
| DNN | Data Network Name | MSID | Mobile Station | SN | Secondary Node, |
| | | | Identifier | | Sequence Number |
| DNAI | Data Network Access | MSIN | Mobile Station | SoC | System on Chip |
| | Identifier | | Identification Number | | |
| DRB | Data Radio Bearer | MSISDN | Mobile Subscriber | SON | Self-Organizing |
| | | | ISDN Number | | Network |
| DRS | Discovery Reference | MT | Mobile Terminated, | SpCell | Special Cell |
| | Signal | | Mobile Termination | | |
| DRX | Discontinuous Reception | MTC | Machine-Type | SP-CSI-RNTI | Semi-Persistent |
| | | | Communications | | CSI RNTI |
| DSL | Domain Specific | mMTC | massive MTC, massive | SPS | Semi-Persistent |
| | Language. Digital | | Machine-Type | | Scheduling |
| | Subscriber Line | | Communications | | |
| DSLAM | DSL Access Multiplexer | MU-MIMO | Multi User MIMO | SQN | Sequence number |
| DwPTS | Downlink Pilot Time Slot | MWUS | MTC wake-up signal, | SR | Scheduling Request |
| | | | MTC WUS | | |
| E-LAN | Ethernet Local Area | NACK | Negative | SRB | Signalling Radio |
| | Network | | Acknowledgement | | Bearer |
| E2E | End-to-End | NAI | Network Access | SRS | Sounding Reference |
| | | | Identifier | | Signal |
| ECCA | extended clear channel | NAS | Non-Access Stratum, | SS | Synchronization Signal |
| | assessment, extended | | Non-Access Stratum | | |
| | CCA | | layer | | |
| ECCE | Enhanced Control | NCT | Network Connectivity | SSB | Synchronization Signal |
| | Channel Element, | | Topology | | Block |
| | Enhanced CCE | | | | |
| ED | Energy Detection | NC-JT | Non-Coherent Joint | SSID | Service Set Identifier |
| | | | Transmission | | |
| EDGE | Enhanced Datarates for | NEC | Network Capability | SS/PBCH | Block |
| | GSM Evolution (GSM | | Exposure | | |
| | Evolution) | | | | |
| EAS | Edge Application Server | NE-DC | NR-E-UTRA Dual | SSBRI | SS/PBCH Block |
| | | | Connectivity | | Resource Indicator, |
| | | | | | Synchronization Signal |
| | | | | | Block Resource |
| | | | | | Indicator |
| EASID | Edge Application Server | NEF | Network Exposure | SSC | Session and Service |
| | Identification | | Function | | Continuity |
| ECS | Edge Configuration Server | NF | Network Function | SS-RSRP | Synchronization Signal |
| | | | | | based Reference Signal |
| | | | | | Received Power |
| ECSP | Edge Computing Service | NFP | Network Forwarding | SS-RSRQ | Synchronization Signal |
| | Provider | | Path | | based Reference Signal |
| | | | | | Received Quality |
| EDN | Edge Data Network | NFPD | Network Forwarding | SS-SINR | Synchronization Signal |
| | | | Path Descriptor | | based Signal to Noise |
| | | | | | and Interference Ratio |
| EEC | Edge Enabler Client | NFV | Network Functions | SSS | Secondary |
| | | | Virtualization | | Synchronization Signal |
| EECID | Edge Enabler Client | NFVI | NFV Infrastructure | SSSG | Search Space Set |
| | Identification | | | | Group |
| EES | Edge Enabler Server | NFVO | NFV Orchestrator | SSSIF | Search Space Set |
| | | | | | Indicator |
| EESID | Edge Enabler Server | NG | Next Generation, Next | SST | Slice/Service Types |
| | Identification | | Gen | | |
| EHE | Edge Hosting | NGEN-DC | NG-RAN E-UTRA- | SU-MIMO | Single User MIMO |
| | Environment | | NR Dual Connectivity | | |
| EGMF | Exposure Governance | NM | Network Manager | SUL | Supplementary Uplink |
| | tableManagement | | | | |
| | Function | | | | |
| EGPRS | Enhanced GPRS | NMS | Network Management | TA | Timing Advance, |
| | | | System | | Tracking Area |
| EIR | Equipment Identity | N-POP | Network Point of | TAC | Tracking Area Code |
| | Register | | Presence | | |
| eLAA | enhanced Licensed | NMIB, N-MIB | Narrowband MIB | TAG | Timing Advance Group |
| | Assisted Access, enhanced | | | | |
| | LAA | | | | |
| EM | Element Manager | NPBCH | Narrowband Physical | TAI | Tracking Area Identity |
| | | | Broadcast CHannel | | |
| eMBB | Enhanced Mobile | NPDCCH | Narrowband Physical | TAU | Tracking Area Update |
| | Broadband | | Downlink Control | | |
| | | | CHannel | | |
| EMS | Element Management | NPDSCH | Narrowband Physical | TB | Transport Block |
| | System | | Downlink Shared | | |
| | | | CHannel | | |
| eNB | evolved NodeB, E- | NPRACH | Narrowband Physical | TBS | Transport Block Size |
| | UTRAN Node B | | Random Access | | |
| | | | CHannel | | |
| EN-DC | E-UTRA-NR Dual | NPUSCH | Narrowband Physical | TBD | To Be Defined |
| | Connectivity | | Uplink Shared | | |
| | | | CHannel | | |
| EPC | Evolved Packet Core | NPSS | Narrowband Primary | TCI | Transmission |
| | | | Synchronization Signal | | Configuration Indicator |
| EPDCCH | enhanced PDCCH, | NSSS | Narrowband | TCP | Transmission |
| | enhanced Physical | | Secondary | | Communication |
| | Downlink Control Cannel | | Synchronization Signal | | Protocol |
| EPRE | Energy per resource | NR | New Radio, Neighbour | TDD | Time Division Duplex |
| | element | | Relation | | |
| EPS | Evolved Packet System | NRF | NF Repository | TDM | Time Division |
| | | | Function | | Multiplexing |
| EREG | enhanced REG, enhanced | NRS | Narrowband Reference | TDMA | Time Division Multiple |
| | resource element groups | | Signal | | Access |
| ETSI | European | NS | Network Service | TE | Terminal Equipment |
| | Telecommunications | | | | |
| | Standards Institute | | | | |
| ETWS | Earthquake and Tsunami | NSA | Non-Standalone | TEID | Tunnel End Point |
| | Warning System | | operation mode | | Identifier |
| eUICC | embedded UICC, | NSD | Network Service | TFT | Traffic Flow Template |
| | embedded Universal | | Descriptor | | |
| | Integrated Circuit Card | | | | |
| E-UTRA | Evolved UTRA | NSR | Network Service | TMSI | Temporary Mobile |
| | | | Record | | Subscriber Identity |
| E-UTRAN | Evolved UTRAN | NSSAI | Network Slice | TNL | Transport Network |
| | | | Selection Assistance | | Layer |
| | | | Information | | |
| EV2X | Enhanced V2X | S-NNSAI | Single-NSSAI | TPC | Transmit Power |
| | | | | | Control |
| F1AP | F1 Application Protocol | NSSF | Network Slice | TPMI | Transmitted Precoding |
| | | | Selection Function | | Matrix Indicator |
| F1-C | F1 Control plane interface | NW | Network | TRP, TRxP | Technical Report |
| F1-U | F1 User plane interface | NWUS | Narrowband wake-up | | Transmission |
| | | | signal, Narrowband | | Reception Point |
| | | | WUS | | |
| FACCH | Fast Associated Control | NZP | Non-Zero Power | TRS | Tracking Reference |
| | CHannel | | | | Signal |
| FACCH/F | Fast Associated Control | O&M | Operation and | TRx | Transceiver |
| | Channel/Full rate | | Maintenance | | |
| FACCH/H | Fast Associated Control | ODU2 | Optical channel Data | TS | Technical |
| | Channel/Half rate | | Unit-type 2 | | Specifications, |
| | | | | | Technical Standard |
| FACH | Forward Access Channel | OFDM | Orthogonal Frequency | TTI | Transmission Time |
| | | | Division Multiplexing | | Interval |
| FAUSCH | Fast Uplink Signalling | OFDMA | Orthogonal Frequency | Tx | Transmission, |
| | Channel | | Division Multiple | | Transmitting, |
| | | | Access | | Transmitter |
| FB | Functional Block | OOB | Out-of-band | U-RNTI | UTRAN Radio |
| | | | | | Network Temporary |
| | | | | | Identity |
| FBI | Feedback Information | OOS | Out of Sync | UART | Universal |
| | | | | | Asynchronous |
| | | | | | Receiver and |
| | | | | | Transmitter |
| FCC | Federal Communications | OPEX | OPerating EXpense | UCI | Uplink Control |
| | Commission | | | | Information |
| FCCH | Frequency Correction | OSI | Other System | UE | User Equipment |
| | CHannel | | Information | | |
| FDD | Frequency Division | OSS | Operations Support | UDM | Unified Data |
| | Duplex | | System | | Management |
| FDM | Frequency Division | OTA | over-the-air | UDP | User Datagram |
| | Multiplex | | | | Protocol |
| FDMA | Frequency Division | PAPR | Peak-to-Average | UDSF | Unstructured Data |
| | Multiple Access | | Power Ratio | | Storage Network |
| | | | | | Function |
| FE | Front End | PAR | Peak to Average Ratio | UICC | Universal Integrated |
| | | | | | Circuit Card |
| FEC | Forward Error Correction | PBCH | Physical Broadcast | UL | Uplink |
| | | | Channel | | |
| FFS | For Further Study | PC | Power Control, | UM | Unacknowledged |
| | | | Personal Computer | | Mode |
| FFT | Fast Fourier | PCC | Primary Component | UML | Unified Modelling |
| | Transformation | | Carrier, Primary CC | | Language |
| feLAA | further enhanced Licensed | PCell | Primary Cell | UMTS | Universal Mobile |
| | Assisted Access, further | | | | Telecommunications |
| | enhanced LAA | | | | System |
| FN | Frame Number | PCI | Physical Cell ID, | UP | User Plane |
| | | | Physical Cell Identity | | |
| FPGA | Field-Programmable Gate | PCEF | Policy and Charging | UPF | User Plane Function |
| | Array | | Enforcement Function | | |
| FR | Frequency Range | PCF | Policy Control | URI | Uniform Resource |
| | | | Function | | Identifier |
| FQDN | Fully Qualified Domain | PCRF | Policy Control and | URL | Uniform Resource |
| | Name | | Charging Rules | | Locator |
| | | | Function | | |
| G-RNTI | GERAN Radio Network | PDCP | Packet Data | | URLLC Ultra-Reliable and Low |
| | Temporary Identity | | Convergence Protocol, | | Latency |
| | | | Packet Data | | |
| | | | Convergence Protocol | | |
| | | | layer | | |
| GERAN | GSM EDGE RAN, GSM | PDCCH | Physical Downlink | USB | Universal Serial Bus |
| | EDGE Radio Access | | Control Channel | | |
| | Network | | | | |
| GGSN | Gateway GPRS Support | PDCP | Packet Data | USIM | Universal Subscriber |
| | Node | | Convergence Protocol | | Identity Module |
| GLONASS | GLObal′naya | PDN | Packet Data Network, | USS | UE-specific search |
| | NAvigatsionnaya | | Public Data Network | | space |
| | Sputnikovaya Sistema | | | | |
| | (Engl.: Global Navigation | | | | |
| | Satellite System) | | | | |
| gNB | Next Generation NodeB | PDSCH | Physical Downlink | UTRA | UMTS Terrestrial |
| | | | Shared Channel | | Radio Access |
| gNB-CU | gNB-centralized unit, Next | PDU | Protocol Data Unit | UTRAN | Universal Terrestrial |
| | Generation NodeB | | | | Radio Access Network |
| | centralized unit | | | | |
| gNB-DU | gNB-distributed unit, Next | PEI | Permanent Equipment | UwPTS | Uplink Pilot Time Slot |
| | Generation NodeB | | Identifiers | | |
| | distributed unit | | | | |
| GNSS | Global Navigation | PFD | Packet Flow | V2I | Vehicle-to- |
| | Satellite System | | Description | | Infrastruction |
| GPRS | General Packet Radio | P-GW | PDN Gateway | V2P | Vehicle-to-Pedestrian |
| | Service | | | | |
| GPSI | Generic Public | PHICH | Physical hybrid-ARQ | V2V | Vehicle-to-Vehicle |
| | Subscription Identifier | | indicator channel | | |
| GSM | Global System for Mobile | PHY | Physical layer | V2X | Vehicle-to-everything |
| | Communications, Groupe | | | | |
| | Special Mobile | | | | |
| GTP | GPRS Tunneling Protocol | PLMN | Public Land Mobile | VIM | Virtualized |
| | | | Network | | Infrastructure Manager |
| GTP-U | GPRS Tunnelling Protocol | PIN | Personal Identification | VL | Virtual Link, |
| | for User Plane | | Number | | |
| GTS | Go To Sleep Signal | PM | Performance | VLAN | Virtual LAN, Virtual |
| | (related to WUS) | | Measurement | | Local Area Network |
| GUMMEI | Globally Unique MME | PMI | Precoding Matrix | VM | Virtual Machine |
| | Identifier | | Indicator | | |
| GUTI | Globally Unique | PNF | Physical Network | VNF | Virtualized Network |
| | Temporary UE Identity | | Function | | Function |
| HARQ | Hybrid ARQ, Hybrid | PNFD | Physical Network | VNFFG | VNF Forwarding |
| | Automatic Repeat Request | | Function Descriptor | | Graph |
| HANDO | Handover | PNFR | Physical Network | VNFFGD | VNF Forwarding |
| | | | Function Record | | Graph Descriptor |
| HFN | HyperFrame Number | POC | PTT over Cellular | VNFM | VNF Manager |
| HHO | Hard Handover | PP, PTP | Point-to-Point | VoIP | Voice-over-IP, Voice- |
| | | | | | over-Internet Protocol |
| HLR | Home Location Register | PPP | Point-to-Point Protocol | VPLMN | Visited Public Land |
| | | | | | Mobile Network |
| HN | Home Network | PRACH | Physical RACH | VPN | Virtual Private |
| | | | | | Network |
| HO | Handover | PRB | Physical resource | VRB | Virtual Resource Block |
| | | | block | | |
| HPLMN | Home Public Land Mobile | PRG | Physical resource | WiMAX | Worldwide |
| | Network | | block group | | Interoperability for |
| | | | | | Microwave Access |
| HSDPA | High Speed Downlink | ProSe | Proximity Services, | WLAN | Wireless Local Area |
| | Packet Access | | Proximity-Based | | Network |
| | | | Service | | |
| HSN | Hopping Sequence | PRS | Positioning Reference | WMAN | Wireless Metropolitan |
| | Number | | Signal | | Area Network |
| HSPA | High Speed Packet Access | PRR | Packet Reception | WPAN | Wireless Personal Area |
| | | | Radio | | Network |
| HSS | Home Subscriber Server | PS | Packet Services | X2-C | X2-Control plane |
| HSUPA | High Speed Uplink Packet | PSBCH | Physical Sidelink | X2-U | X2-User plane |
| | Access | | Broadcast Channel | | |
| HTTP | Hyper Text Transfer | PSDCH | Physical Sidelink | XML | extensible Markup |
| | Protocol | | Downlink Channel | | Language |
| HTTPS | Hyper Text Transfer | PSCCH | Physical Sidelink | XRES | EXpected user |
| | Protocol Secure (https is | | Control Channel | | RESponse |
| | http/1.1 over SSL, i.e. port | | | | |
| | 443) | | | | |
| I-Block | Information Block | PSSCH | Physical Sidelink | XOR | eXclusive OR |
| | | | Shared Channel | | |
| ICCID | Integrated Circuit Card | PSCell | Primary SCell | ZC | Zadoff-Chu |
| | Identification | | | | |
| IAB | Integrated Access and | PSS | Primary | ZP | Zero Po |
| | Backhaul | | Synchronization Signal | | |
| ICIC | Inter-Cell Interference | PSTN | Public Switched | | |
| | Coordination | | Telephone Network | | |
| ID | Identity, identifier | PT-RS | Phase-tracking | | |
| | | | reference signal | | |
| IDFT | Inverse Discrete Fourier | PTT | Push-to-Talk | | |
| | Transform | | | | |
| IE | Information element | PUCCH | Physical Uplink | | |
| | | | Control Channel | | |

What is claimed is:

1. An apparatus for use in a user equipment (UE), the apparatus comprising processing circuitry and memory, wherein the processing circuitry is configured to:
identify beta offset values for multiplexing hybrid automatic repeat request acknowledgment (HARQ-ACK) information in a physical uplink shared channel (PUSCH);
determine that high-priority (HP) HARQ-ACK information and low-priority (LP) HARQ-ACK information are to be multiplexed onto the PUSCH;
determine, based on the beta offset values, a total amount of PUSCH resources available for multiplexing the HP HARQ-ACK information, the LP HARQ-ACK information, and uplink control information (UCI);
identify a first beta offset value for the HP HARQ-ACK information and a second beta offset value for the LP HARQ-ACK information from the beta offset values; and
multiplex the HP HARQ-ACK information, the LP HARQ-ACK information, and the UCI onto the PUSCH based on the first beta value, the second beta value, and the total amount of PUSCH resources.

2. The apparatus of claim 1, wherein the beta offset values are indicative of a number of bits used to multiplex the HP HARQ-ACK information and the LP HARQ-ACK information.

3. The apparatus of claim 1, wherein the first beta offset value and the second beta offset value are identified based on a beta offset indicator field in a downlink control information (DCI) format for the PUSCH.

4. The apparatus of claim 3, wherein mapping of a codepoint of the beta offset indicator field to a beta offset value is dependent on a multiplexing scenario for the HP HARQ-ACK information, the LP HARQ-ACK information, and the UCI.

5. The apparatus of claim 1, wherein the PUSCH is a configured-grant PUSCH.

6. The apparatus of claim 1, wherein channel state information (CSI) is multiplexed onto the PUSCH using an offset value separate from the first beta offset value and the second beta offset value.

7. A non-transitory computer-readable medium comprising instructions that when executed by processing circuitry of user equipment (UE), cause the processing circuitry to:
identify beta offset values for multiplexing hybrid automatic repeat request acknowledgment (HARQ-ACK) information in a physical uplink shared channel (PUSCH);
determine that high-priority (HP) HARQ-ACK information and low-priority (LP) HARQ-ACK information are to be multiplexed onto the PUSCH;
determine, based on the beta offset values, a total amount of PUSCH resources available for multiplexing the HP HARQ-ACK information, the LP HARQ-ACK information, and uplink control information (UCI);
identify a first beta offset value for the HP HARQ-ACK information and a second beta offset value for the LP HARQ-ACK information from the beta offset values; and
multiplex the HP HARQ-ACK information, the LP HARQ-ACK information, and the UCI onto the PUSCH based on the first beta value, the second beta value, and the total amount of PUSCH resources.

8. The non-transitory computer-readable medium of claim 7, wherein the beta offset values are indicative of a number of bits used to multiplex the HP HARQ-ACK information and the LP HARQ-ACK information.

9. The non-transitory computer-readable medium of claim 7, wherein the first beta offset value and the second beta offset value are identified based on a beta offset indicator field in a downlink control information (DCI) format for the PUSCH.

10. The non-transitory computer-readable medium of claim 9, wherein mapping of a codepoint of the beta offset indicator field to a beta offset value is dependent on a multiplexing scenario for the HP HARQ-ACK information, the LP HARQ-ACK information, and the UCI.

11. The non-transitory computer-readable medium of claim 7, wherein the PUSCH is a configured-grant PUSCH.

12. The non-transitory computer-readable medium of claim 7, wherein channel state information (CSI) is multiplexed onto the PUSCH using an offset value separate from the first beta offset value and the second beta offset value.

13. An apparatus of user equipment (UE), the apparatus comprising:
memory coupled to processor circuitry configured to:
determine that HARQ-ACK priority one information and HARQ-ACK priority zero information are to be multiplexed onto a physical uplink shared channel (PUSCH) with uplink control information (UCI);
identify a first beta offset value for the HARQ-ACK priority one information and a second beta offset value for the HARQ-ACK priority zero information; and
multiplex the HARQ-ACK priority one information, the HARQ-ACK priority zero information, and the UCI onto the PUSCH based on the first beta value and the second beta value.
